(19) United States
(12) Patent Application Publication
(10) Pub. No.: US 2018/0295197 A1
(43) Pub. Date: Oct. 11, 2018

(54) METHOD FOR RESOURCE MAPPING BETWEEN RESTFUL SERVER AND ONEM2M SYSTEM

(71) Applicant: Samsung Electronics Co., Ltd., Gyeonggi-do (KR)

(72) Inventors: Kiran Bharadwaj VEDULA, Bangalore (IN); Jieun KEUM, Gyeonggi-do (KR); Jinhyeock CHOI, Gyeonggi-do (KR)

(21) Appl. No.: 15/767,060

(22) PCT Filed: Oct. 7, 2016
(86) PCT No.: PCT/KR2016/011243

§ 371 Date: Apr. 9, 2018

(30) Foreign Application Priority Data
Oct. 7, 2015 (IN) 5380/CHE/2015

(51) Int. Cl. H04L 29/08; H04W 80/08

(52) U.S. Cl. CPC H04L 67/16; H04W 4/70; H04W 80/085; H04L 67/2823

(57) ABSTRACT

The present disclosure relates to a pre-5^{th}-Generation (5G) or 5G communication system to be provided for supporting higher data rates Beyond 4^{th}-Generation (4G) communication system such as Long Term Evolution (LTE). Embodiments herein provide an oneM2M system. The oneM2M system includes an interworking proxy entity (IPE) and a oneM2M client. The IPE is configured to discover resources hosted by a RESTful server. The RESTful server is external to the oneM2M system. The IPE is configured to create an application entity (AE) resource associated with the RESTful server. The IPE is configured to create one or more containers with labels indicating information of resources associated with the RESTful server. Each container includes a content instance (CI) resource having a representation of mapped resources associated with the RESTful server. Further, the IPE is configured to send service subscription information update about the discovered RESTful server to a middle node. The oneM2M client is configured to send a request to the IPE to discover the container from the IPE using the labels.

### TECHNICAL FIELD

The embodiments herein relate to oneM2M system, and more particularly relates to a method for resource mapping between a representational state transfer (RESTful) server and the oneM2M system. The present application is based on, and claims priority from an Indian Application Number 5380/CHE/2015 filed on 7 Oct. 2015, the disclosure of which is hereby incorporated by reference herein.

### BACKGROUND ART

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’.

The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems.

In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like.

In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

In general, machine-to-machine (M2M) communication refers to communication between two devices. The communication is initiated by an application residing on one of the device to collect or send information to an application residing on another device. Various standards are available to provide connectivity to wireless devices. For example, the Internet Protocol (IP) is a framework by which the device can be communicatively coupled with other devices, based on an IP address assigned to the devices.

The oneM2M has emerged as a set of standards for M2M and the internet of things (IoT). In particular, oneM2M standardizes a common services layer for M2M communication. Further, there exist various services provided by M2M service providers. The services include smart home service or smart city service. For example, the M2M service can be an energy metering service which includes measuring energy consumption of each appliance in a smart home and sending those measurements to a remote server.

There exists open interconnect consortium (OIC) devices which are considered as home devices such as bulbs, refrigerators, washing machines and so on which cannot be part of the services provided by the M2M service providers. Further, the OIC devices have a set of resources (which provide functionality), but the oneM2M standard cannot provide many resource types to map these OIC resources.

### DISCLOSURE OF INVENTION

### Technical Problem

In existing systems, a new OIC device cannot become a part of users existing service subscription. In an example, a smart refrigerator cannot be added to the devices in the smart home which are subscribed to an existing smart home service subscription. Hence, there is a need to enable OIC devices to be a part of M2M services provided by M2M service providers.

The above information is presented as background information only to help the reader to understand the present invention. Applicants have made no determination and make no assertion as to whether any of the above might be applicable as Prior Art with regard to the present application.

### Solution to Problem

The principal object of the embodiments herein is to provide a method for resource mapping between a RESTful server and an oneM2M system.

Another object of the embodiments herein is to provide a method for discovering the RESTful server by the oneM2M system.

Another object of the embodiments herein is to provide a method for providing oneM2M services to the RESTful server.

Another object of the embodiments herein is to provide a method for providing interworking of the RESTful server and the oneM2M system.

Another object of the embodiments herein is to provide a method for enabling the RESTful server to be a part of existing service subscription in the oneM2M system.

Accordingly the embodiments herein provide a oneM2M system. The oneM2M system includes an interworking proxy entity (IPE) and an oneM2M client. The IPE is configured to discover resources hosted by a RESTful server. The RESTful server is external to the oneM2M system. The IPE is configured to create an application entity (AE) resource associated with the RESTful server. The IPE is configured to create one or more containers with labels indicating information of resources associated with the RESTful server. Each container associates with a content instance (CI) resource having a representation of mapped resources associated with the RESTful server. Further, the IPE is configured to send service subscription information update about the discovered RESTful server to a middle node. The oneM2M client is configured to send a request to the IPE to discover the container from the IPE using the labels.

In an embodiment, the IPE includes a RESTful client and an oneM2M server.

The oneM2M server is configured to detect an event to obtain updated resource information from the RESTful server.

The RESTful client is configured to send a request to obtain the updated resource information to the OIC server.

The oneM2M server is configured to update the CI with the updated resource information of the RESTful server. The oneM2M server is further configured to send the updated CI to the oneM2M client.

Accordingly the embodiments herein provide a method implemented in an interworking proxy entity (IPE). The method includes discovering resources hosted by a RESTful server. The method includes creating an application entity (AE) resource associated with the RESTful server. The method includes creating one or more containers with labels indicating information of resources associated with the RESTful server. Each container associates with a content instance (CI) resource having a representation of mapped resources associated with the RESTful server. The method includes sending service subscription information update about the discovered RESTful server to a middle node.

Accordingly the embodiments herein provide a computer program product comprising computer executable program code recorded on a computer readable non-transitory storage medium, the computer executable program code when executed causing the actions including discovering resources hosted by a RESTful server. The computer executable program code when executed causing the further actions including creating an application entity (AE) resource associated with the RESTful server. The computer executable program code when executed causing the further actions including creating one or more containers with labels indicating information of resources associated with the RESTful server. Each container associates with a content instance (CI) resource having a representation of mapped resources associated with the RESTful server. The computer executable program code when executed causing the further actions including sending service subscription information update about the discovered RESTful server to a middle node.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### Advantageous Effects of Invention

Unlike the conventional methods, the proposed method provides resource mapping between a RESTful server and the oneM2M system. The proposed method allows the oneM2M system to discover the RESTful server. With the proposed method, the RESTful server can avail the services provided by the oneM2M service providers. Further, the proposed method allows interworking of the RESTful server and the oneM2M system. Further, the proposed method allows addition of a new OIC physical device (i.e., the RESTful server) to an existing service subscription of the oneM2M system.

### BRIEF DESCRIPTION OF DRAWINGS

This invention is illustrated in the accompanying drawings, throughout which like reference letters indicate corresponding parts in the various figures. The embodiments herein will be better understood from the following description with reference to the drawings, in which:

FIG. 1 illustrates an architecture including are presentational state transfer (REST) RESTful server and an oneM2M system, according to the embodiments as disclosed herein;

FIG. 2 illustrates an example structure of the RESTful server described in the FIG. 1, according to the embodiments as disclosed herein;

FIG. 3 is a flow diagram illustrating a method for resource mapping between the RESTful server and the oneM2M system, according to the embodiments as disclosed herein;

FIG. 4 is a sequence diagram illustrating various signaling messages for resource mapping between the RESTful server and the oneM2M system, according to the embodiments as disclosed herein;

FIG. 5 illustrates an example scenario of mapping of plurality of OIC resources to each container and labels, according to the embodiments as disclosed herein; and

FIG. 6 illustrates a computing environment implementing the method for resource mapping between the RESTful server and the oneM2M system, according to the embodiments as disclosed herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

Throughout the description, the term open interconnect consortium (OIC) device refers to a RESTful server that supports a RESTful architecture. Further, the OIC resources denote the resources supported by the RESTful server.

The embodiments herein provide an oneM2M system. The oneM2M system includes an interworking proxy entity (IPE) and a oneM2M client. The IPE is configured to discover resources hosted by a RESTful server. The RESTful server is external to the oneM2M system. The IPE is configured to create an application entity (AE) resource associated with the RESTful server. The IPE is configured to create one or more containers with labels indicating information of resources associated with the RESTful server. Each container associates with a content instance (CI) resource having a representation of mapped resources associated with the RESTful server. Further, the IPE is configured to send service subscription information update about the discovered RESTful server to a middle node. The oneM2M client is configured to send a request to the IPE to discover the container from the IPE using the labels.

Unlike the conventional methods, the proposed method provides resource mapping between a RESTful server and the oneM2M system. The proposed method allows theoneM2M system to discover the RESTful server. With the proposed method, the RESTful server can avail the services provided by the oneM2M service providers. Further, the proposed method allows interworking of the RESTful server and the oneM2M system. Further, the proposed method allows addition of a new OIC physical device (i.e., the RESTful server) to an existing service subscription of the oneM2M system.

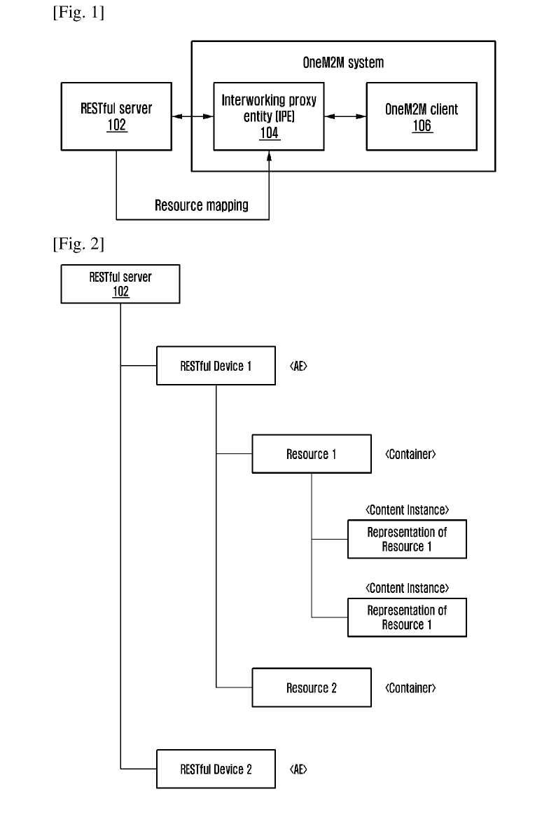

Referring now to the drawings and more particularly to FIGS. 1 through 6 where similar reference characters denote corresponding features consistently throughout the figures, there are shown preferred embodiments.

FIG. 1 illustrates an architecture including a RESTful server 102 and an oneM2M system, according to the embodiments as disclosed herein. As depicted in the FIG. 1, the oneM2M system includes an interworking proxy entity (IPE) 104 and an oneM2M client 106. The RESTful server 102 is external to the oneM2M system as shown in the FIG. 1.

In an example, the RESTful server 102 can be representing a Hue bulb, an OIC refrigerator, an LWM2M washing machine, an electronic device or any other home appliance or the like. The RESTful server 102 and the oneM2M system support RESTful architecture.

The IPE 104 acts as an intermediary between the RESTful server and the oneM2M client 106. The IPE 104 communicates with the oneM2M client 106, for example a smart phone.

Initially, the IPE 104 discovers resources hosted by the RESTful server 102. The RESTful server 102 consists of a core resource (identified with a uniform resource identifier (URI)) and device specific resources (not shown). The core resource has pre-defined resource name which can be accessed through a fixed URI. An example URI can be/oic/res. A RESTful client sends a GET request to the URI for the first time. In response, the RESTful server 102 provides a list of supported resources URI's. Using this list, the RESTful client can further probe the RESTful server 102 to obtain more information. The specific resources have variable resource names and represents specific functionality (e.g. binary switch, brightness and so on).

After discovering the resources hosted by the RESTful server 102, the IPE 104 creates an application entity (AE) resource associated with the RESTful server 102. The AE resource is created by the IPE to determine whether the discovered resources are specific to the RESTful server 102. In an example, the AE resource includes labels such as OIC-DT (device type) and the technology. OIC-DT could have values like ‘oic.d.light’ and technology could have values like ‘OIC’.

Further, the IPE 104 creates one or more containers with labels indicating information of resources associated with the RESTful server 102. Each container associates with a CI resource having a representation of mapped resources associated with the RESTful server 102. An instance of container resource is known as CI resource.

The containers support labels as defined below:
Technology: technology for e.g. OIC
Entity-Type: for e.g. OIC resource type like ‘oic.r.temperature’
Entity-ID: Resource URI
OIC-IF: Resource interfaces supported
Content-Type: The encoding format used for e.g. JSON, CBOR
TTL: Time to live for e.g. 60 seconds

Further, the IPE 104 sends a service subscription information update about the discovered RESTful server 102 to a middle node (not shown in the FIG. 1). In an example, the middle node is an oneM2M backend node. In an example, the service can be an energy metering service provided by the oneM2M service provider. After discovering the RESTful server 102, the IPE 104 sends the service subscription information update about the discovered RESTful server to the middle node. The service subscription information update is to indicate the middle node that the RESTful server 102 (i.e., the OIC device) is added to an existing service subscription.

The oneM2M client 106 sends a request to the IPE 104 to discover the container from the IPE using the labels. In an example, the request is a GET Container message (filter with labels). The GET Container message (filter with labels) enables the oneM2M client to discover only the required RESTful server 102. The other devices in the network are not discovered again at the oneM2M client by filtering with labels.

Further, the IPE 104 detects an event to obtain updated resource information from the RESTful server 102. In an embodiment, the event is detected by the IPE 104 automatically at periodic time intervals.

In an embodiment, the event can be triggered by the oneM2M client 106 dynamically at regular instances of time.

After detecting the event, the IPE 104 sends a request to obtain the updated resource information to the RESTful server 102. In an example, the request sent to the RESTful server 102 is a GET (resource) message. The RESTful server 102 sends the resource information in response to the GET (resource) message from the IPE 104. Further, the IPE 104 updates the CI resource with updated resource information received from the RESTful server 102. In an example, initial container resources can indicate that the bulb (i.e., the OIC device or the RESTful server 102) is OFF. At a later point of time, the bulb may be turned ON. When the IPE 104 sends the GET (resource) message to the RESTful server 102, the updated resource information (which indicates that the bulb is ON) can be obtained and the CI is updated with the updated resource information received from the RESTful server 102. Further, the updated CI is sent to the oneM2M client 106. Thus, the oneM2M client 106 can have latest information of the resources associated with the RESTful server 102.

With the proposed method, the RESTful server 102 can be discovered by the oneM2M system and the RESTful server 102 can be made to avail the services provided by the oneM2M system.

Although the FIG. 1 shows that the oneM2M system includes limited components, it should be noted that the oneM2M system includes many other components, other than the components shown in the FIG. 1.

FIG. 2 illustrates an example structure of the RESTful server 102 described in the FIG. 1, according to the embodiments as disclosed herein. The FIG. 2 shows a tree like structure supported by the RESTful server 102. As depicted in the FIG. 2, the RESTful server 102 includes one or more logical RESTful devices such as RESTful device 1 and RESTful device 2. Further, each RESTful device includes one or more resources. As shown in the FIG. 2, the RESTful device 1 includes resource 1 and resource 2. Each resource can have a representation at any instance of time. In the FIG. 2, the resource 1 has two resource representations i.e., two different states at different times.

With respect to the FIG. 2, it should be noted that the RESTful server 102 is mapped to a <node> oneM2M resource as there are multiple logical RESTful devices supported in this case. Each logical RESTful device is mapped to an <AE> resource. Each resource is mapped to a <container> resource and the resource representation is mapped to a <content instance> resource.

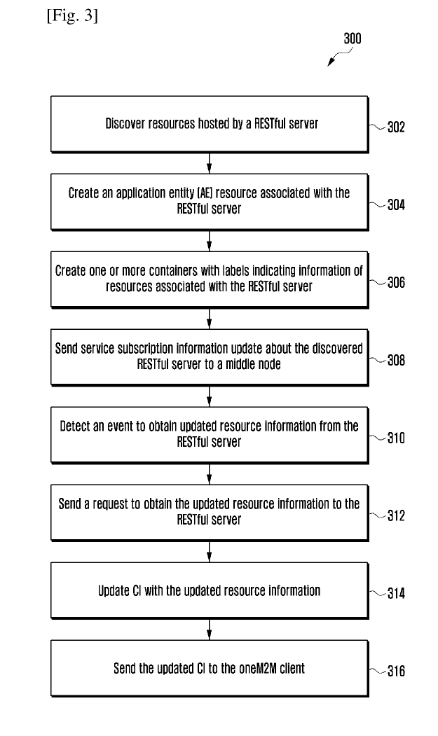

FIG. 3 is a flow diagram 300 illustrating a method for resource mapping between the RESTful server and the oneM2M system, according to the embodiments as disclosed herein. At step 302, the method includes discovering resources hosted by the RESTful server 102. The method allows the IPE 104 to discover the resources hosted by the RESTful server 102. The RESTful server 102 consists of a core resource and multiple device specific resources. The core resource has a pre-defined resource name which can be accessed through fixed URI. The device specific resources have variable resource name and represents specific functionality (e.g. binary switch, brightness and so on). The IPE 104 sends discover resources message to the RESTful server 102 for discovering the resources hosted by the RESTful server.

At step 304, the method includes creating the AE resource associated with the RESTful server 102. The method allows the IPE 104 to create the AE resource associated with the RESTful server 102. After discovering the resources hosted by the RESTful server 102, the IPE 104 creates the AE resource associated with the RESTful server 102. The AE resource is created by the IPE to determine whether the discovered resources are specific to the RESTful server 102. In an example, the AE resource can include labels such as OIC-DT (device type) and the technology.

At step 306, the method includes creating the one or more containers with labels indicating information of resources associated with the RESTful server 102. The method allows the IPE to create the one or more containers with labels indicating information of resources associated with the RESTful server 102. Each container associates with a CI resource having a representation of mapped resources associated with the RESTful server 102. An instance of container resource is known as the CI resource.

At step 308, the method includes sending the service subscription information update about the discovered RESTful server 102 to the middle node. The method allows the IPE to send the service subscription information update about the discovered RESTful server to the middle node. The IPE 104 sends a service subscription information update about the discovered RESTful server 102 to the middle node (not shown in the FIG. 1). The middle node can be any node which forms a part of the oneM2M system. In an example, the middle node is an oneM2M backend node. In an example, the service can be an energy metering service provided by the oneM2M service provider. After discovering the RESTful server 102, the IPE 104 sends the service subscription information update about the discovered RESTful server to the middle node. The service subscription information update is to indicate the middle node that the RESTful server (i.e., the OIC device) is added to an existing service subscription.

At step 310, the method includes detect the event to obtain updated resource information from the RESTful server 102. The method allows the IPE 104 to detect the event to obtain updated resource information from the RESTful server 102. In an embodiment, the event is detected by the IPE 104 automatically at periodic time intervals.

In an embodiment, the event is triggered by the oneM2M client 106 dynamically at regular instances of time.

At step 312, the method includes sending a request to obtain the updated resource information to the RESTful server 102. The method allows the IPE to send the request to obtain the updated resource information to the RESTful server 102. After detecting the event, the IPE 104 sends the request to obtain the updated resource information to the RESTful server 102. In an example, the request sent to the RESTful server 102 is a GET (resource) message. The RESTful server 102 sends the resource information in response to the GET (resource) message from the IPE 104. In an example, initial container resources can indicate that the temperature of a microwave oven (i.e., the OIC device or the RESTful server 102) is 40 degrees. At a later point of time, the Oven may be at the temperature of 100 degrees. When the IPE 104 sends the GET (resource) message to the RESTful server 102, the updated resource information (which indicates that the temperature is 100 degrees) can be obtained.

At step 314, the method includes updating the CI with the updated resource information. The method allows the IPE 104 to update the CI with the updated resource information. In an example, the CI, which denotes the temperature as 100 degrees, is updated to the CI.

At step 316, the method includes sending the updated CI to the oneM2M client 106. The method allows the IPE 104 to send the updated CI to the oneM2M client 106. Thus, the oneM2M client 106 can have latest information of the resources associated with the RESTful server 102.

The various actions, acts, blocks, steps, or the like in the method may be performed in the order presented, in a different order or simultaneously. Further, in some embodiments, some of the actions, acts, blocks, steps, or the like may be omitted, added, modified, skipped, or the like without departing from the scope of the invention.

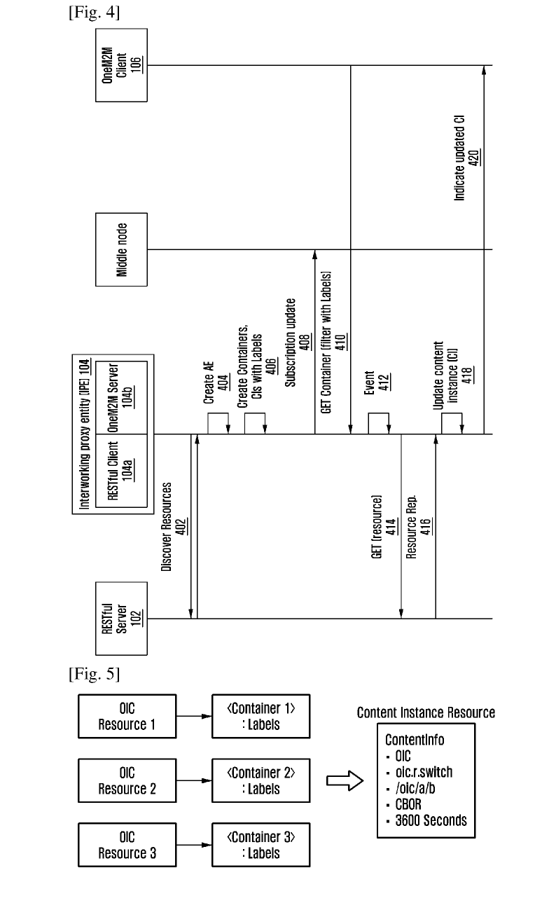

FIG. 4 is a sequence diagram illustrating various signaling messages for resource mapping between the RESTful server and the oneM2M system, according to the embodiments as disclosed herein. As depicted in the sequence diagram, initially a RESTful client 104a sends (402) discover resources message to the RESTful server 102 for discovering the resources hosted by the RESTful server 102. In response to the discover resources message, the RESTful server 102 sends the supported resources to the RESTful client 104a.

The oneM2M server 104b creates (404) the AE resource associated with the RESTful server 102. The AE resource is created by the IPE to determine whether the discovered resources are specific to the RESTful server 102. In an example, the AE resource can include labels such as OIC-DT (device type) and the technology.

Further, the oneM2M server 104b creates (406) the one or more containers with labels indicating information of resources associated with the RESTful server 102. Each container associates with a CI resource having a representation of mapped resources associated with the RESTful server 102.

The IPE 104 sends (408) the service subscription information update about the discovered RESTful server 102 to the middle node. The middle node can be any node which forms a part of the oneM2M system. In an example, the middle node is an oneM2M backend node.

The oneM2M client 106 sends (410) a GET Container message (filter with labels) to the oneM2M server 104b. The GET Container message (filter with labels) enables the oneM2M client to discover only the RESTful server 102. The other devices in the network are not discovered again at the oneM2M client 106 by filtering with labels. Further, the IPE 104 detects (412) the event to obtain updated resource information from the RESTful server 102. In an embodiment, the event is detected by the IPE 104 automatically at periodic time intervals.

In an embodiment, the event can be triggered by the oneM2M client 106 dynamically at regular instances of time.

After detecting the event, the RESTful Client 104a sends (414) a GET (resource) message to the RESTful server 102 to obtain the updated resource information. In an example, initial container resources can indicate that the temperature of a microwave oven (i.e., the OIC device or the RESTful server 102) is 40 degrees. At a later point of time, the Oven may be at the temperature of 100 degrees. When the IPE 104 sends the GET (resource) message to the RESTful server 102, the updated resource information (which indicates that the temperature is 100 degrees) can be obtained. The RESTful server 102 sends (416) the resource information in response to the GET (resource) message from the RESTful client 104a.

The oneM2M server 104b updates (418) the CI with the updated resource information received from the RESTful server 102. Further, the oneM2M server 104b sends (420) the updated CI to the oneM2M client 106.

FIG. 5 illustrates an example scenario of mapping plurality of OIC resources to each container and labels, according to the embodiments as disclosed herein. As depicted in the FIG. 5, each OIC resource (i.e., an OIC resource 1, an OIC resource 2 and an OIC resource 3) associated with the RESTful server 102 is mapped to a container (i.e., a container 1, a container 2 and a container 3). Each OIC resource is mapped as <container> resource.

Each OIC resource is mapped to a container resource, where each container resource supports a plurality of labels as shown in the FIG. 5. <Container> resource supported labels are—technology, entity type, entity ID, OIC-IF, content-type, TTL (i.e., the lifetime of the advertised information).

Each container associates with a CI resource. The instance of the container is denoted as the CI resource. The CI resource includes a representation of mapped resources associated with the RESTful server as shown in the FIG. 5. A CI resource for e.g. includes the following values for labels: technology as OIC, entity type as oic.r.switch, Resource URI as/oic/a/b, content-type as CBOR and TTL as 3600 seconds.

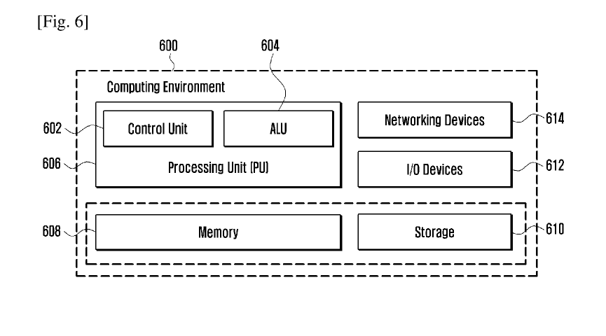

FIG. 6 illustrates a computing environment implementing the method for resource mapping between the RESTful server and the oneM2M system, according to the embodiments as disclosed herein. As depicted in the FIG. 6, the computing environment 600 comprises at least one processing unit 606 that is equipped with a control unit 602 and an Arithmetic Logic Unit (ALU) 604, a memory 608, a storage unit 610, plurality of networking devices 614 and a plurality of Input output (I/O) devices 612. The processing unit 606 is responsible for processing the instructions of the algorithm. The processing unit 606 receives commands from the control unit 602 in order to perform its processing. Further, any logical and arithmetic operations involved in the execution of the instructions are computed with the help of the ALU 604.

The overall computing environment 600 can be composed of multiple homogeneous and/or heterogeneous cores, multiple CPUs of different kinds, special media and other accelerators. The processing unit 606 is responsible for processing the instructions of the algorithm. Further, the plurality of processing units 606 may be located on a single chip or over multiple chips.

The algorithm comprising of instructions and codes required for the implementation are stored in either the memory unit 608 or the storage 610 or both. At the time of execution, the instructions may be fetched from the corresponding memory 608 or storage 610, and executed by the processing unit 606.

In case of any hardware implementations various networking devices 614 or external I/O devices 612 may be connected to the computing environment to support the implementation through the networking unit and the I/O device unit.

The embodiments disclosed herein can be implemented through at least one software program running on at least one hardware device and performing network management functions to control the elements. The elements shown in the FIGS. 1 through 6 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1-6. (canceled)

7. An apparatus supporting a oneM2M system, comprising:
an interworking proxy entity (IPE) configured to:
discover Open Interconnect Consortium (OIC) resources provided by a Representational state transfer (RESTful) server associated with a OIC device, wherein the RESTful server is external to the apparatus;
generate an application entity (AE) resource associated with the OIC device; and
generate at least one container from the discovered OIC resources;
a oneM2M client configured to:
transmit a request to the IPE using the AE resource to discover the at least one container.

8. The apparatus of claim 7, wherein the AE resource and the at least one container comprise labels which represent properties of the OIC resources.

9. The apparatus of claim 8,
wherein the oneM2M client transmits the request using the labels associated with the at least one container, and
wherein the labels comprise at least one of a resource type, a resource Uniform Resource Identifier (URI), a resource interface, and Time To Live (TTL).

10. The apparatus of claim 7, wherein the IPE comprises a RESTful client transmitting a GET message to the RESTful server for discovering the OIC resources.

11. The apparatus of claim 7, wherein the at least one container is associated with a content instance (CI) resource having a representation of the OIC resources provided by the RESTFul server.

12. The apparatus of claim 11, wherein the IPE is further configured to detect an event associated with update of resource information, transmit a request message to obtain updated resource information to the RESTful server, and update the CI with the updated resource information.

13. The apparatus of claim 12, wherein the IPE is further configured to transmit the updated CI to the oneM2M client.

14. A method by an apparatus supporting a oneM2M system, comprising:
discovering, by an interworking proxy entity (IPE) of the apparatus, Open Interconnect Consortium (OIC) resources provided by a Representational state transfer (RESTful) server associated with a OIC device, wherein the RESTful server is external to the apparatus;
generating, by the IPE, an application entity (AE) resource associated with the OIC device;
generating, by the IPE, at least one container from the discovered OIC resources; and
transmitting, by a oneM2M client of the apparatus to the IPE, a request to the IPE using the AE to discover the at least one container.

15. The method of claim 14, wherein the AE resource and the at least one container comprise labels which represent properties of the OIC resources.

16. The method of claim 15,
wherein the request is transmitted using the labels associated with the at least one container, and
wherein the labels comprise at least one of a resource type, a resource Uniform Resource Identifier (URI), a resource interface, and Time To Live (TTL).

17. The method of claim 14, wherein the IPE comprises a RESTful client transmitting a GET message to the RESTful server for discovering the OIC resources.

18. The method of claim 14, wherein the at least one container is associated with a content instance (CI) resource having a representation of the OIC resources provided by the RESTFul server.

19. The method of claim 18, wherein:
an event associated with update of resource information is detected by the IPE,
a request message to obtain updated resource information is transmitted to the RESTful server, and
the CI is updated with the updated resource information.

20. The method of claim 19, wherein the updated CI is transmitted from the IPE to the oneM2M client.
